(19) United States
(12) Patent Application Publication
(10) Pub. No.: US 2009/0060363 A1
(43) Pub. Date: Mar. 5, 2009

(54) SYSTEM AND METHOD FOR IMAGE COMPRESSION

(75) Inventor: Fang-Chen Chang, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX TECHNOLOGIES LIMITED, Tainan County (TW)

(21) Appl. No.: 11/847,387

(22) Filed: Aug. 30, 2007

(51) Int. Cl. G06K 9/36

(52) U.S. Cl. 382/246

(57) ABSTRACT

A system of image compression is disclosed. The system comprises a first encoder, a second encoder and a determining device. The determining device further comprises a quality lost calculator, a code length expense calculator and a selector. The first encoder generates a first coded data. The second encoder generates a second coded data. Next, the quality lost calculator calculates quality lost values of the first coded data and the second coded data. The code length expense calculator calculates code length expense of the first coded data and the second coded data. Finally, the selector calculates total expense values of the first coded data and the second coded data and selectively outputs one of the first coded data and the second coded data according to the total expense values of the first coded data and the second coded data.

### BACKGROUND OF THE INVENTION

1. Field of the Invention

The present invention relates to image compression, and in particular relates to systems and methods of image compression.

2. Description of the Related Art

The rapid growth of digital imaging applications, including desktop publishing, multimedia, teleconferencing, and high-definition television (HDTV) has increased the need for efficient and standardized image compression techniques. Without image compression, the transmission of images would require an unacceptable bandwidth for many applications. As a result, methods of compressing images have been the subject of numerous research publications. Image compression schemes convert an image consisting of a two-dimensional array of pixels into a sequence of bits which are transmitted over a communication link. Each pixel represents the intensity of the image at a particular location therein. The transmission link may be an ordinary telephone line.

Consider an image comprising a gray-scale representation of a photograph at a resolution of 1000×1000 lines. Each pixel typically consists of 8 bits which are used to encode 256 possible intensity levels at the corresponding point on the photograph. Hence, without compression, transmission of the photograph requires that 8 million bits be sent over the communication link. A typical telephone line is capable of transmitting about 9600 bits per second; hence the picture transmission would require more than 10 minutes. Transmission times of this magnitude are unacceptable.

As a result, image compression systems are needed to reduce transmission time. It is also apparent to those skilled in the art that image compression systems may also be advantageously employed in image storage systems to reduce the amount of memory needed to store one or more images.

However, high compression rate demands often lead to low quality in the decoding image. On the other hand, to maintain a high quality from the original image to the decoding data, the compression rate for encoding must be low. Recently, the demands for higher quality images by users are increasing. Thus, quality control plays an important role in image compression. The balance between image quality and image compression rate must be addressed seriously.

### BRIEF SUMMARY OF INVENTION

A detailed description is given in the following embodiments with reference to the accompanying drawings.

A system of image compression is disclosed. The system comprises a first encoder, a second encoder and a determining device. The determining device further comprises a quality lost calculator, a code length expense calculator and a selector. The first encoder is configured to generate a first coded data. The second encoder is configured to generate a second coded data. Next, the determining device is configured to receive the first coded data and the second coded data. After receiving the said data, the quality lost calculator is configured to calculate a first quality lost value of the first coded data and a second quality lost value of the second coded data. The code length expense calculator is configured to calculate a first code length expense of the first coded data and a second code length expense of the second coded data. Finally, the selector is configured to calculate a first total expense value according to the first quality lost value and the first code length expense, a second total expense value according to the second quality lost value and the second code length expense, and to selectively output one of the first coded data and the second coded data according to the first total expense value and the second total expense value.

A method of image data compression is disclosed. First, a first coded data is generated. A second coded data is generated. Next, a first quality lost value of the first coded data is calculated, and a second quality lost value of the second coded data is calculated. Further, a first code length expense of the first coded data is calculated, a second code length expense of the second coded data is calculated. Then, a first total expense value is calculated according to the first quality lost value and the first code length expense, and a second total expense value is calculated according to the second quality lost value and the second code length expense. Finally, one of the first coded data and the second coded data is selectively output according to the first total expense value and the second total expense value.

### BRIEF DESCRIPTION OF DRAWINGS

The present invention can be more fully understood by reading the subsequent detailed description and examples with references made to the accompanying drawings, wherein:

FIG. 1 is a diagram illustrating the system of image compression with quality control disclosed in the embodiment of the invention;

FIG. 2A is a linear chart illustrating the predetermined correlation between SAD and the quality lost value while the original image data is in a high frequency region in an embodiment of the invention;

FIG. 2B is a linear chart illustrating a predetermined correlation between the SAD and the quality lost value while the original image data is in a low frequency region in an embodiment of the invention;

FIG. 3 is a linear chart illustrating the predetermined correlation between the length and the code length expense in an embodiment of the invention; and

FIG. 4 is a flowchart of the method of image compression with quality control.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

To achieve the best compression rate with acceptable image quality, a system and a method of image compression with quality control by dynamic coding methods selection is disclosed.

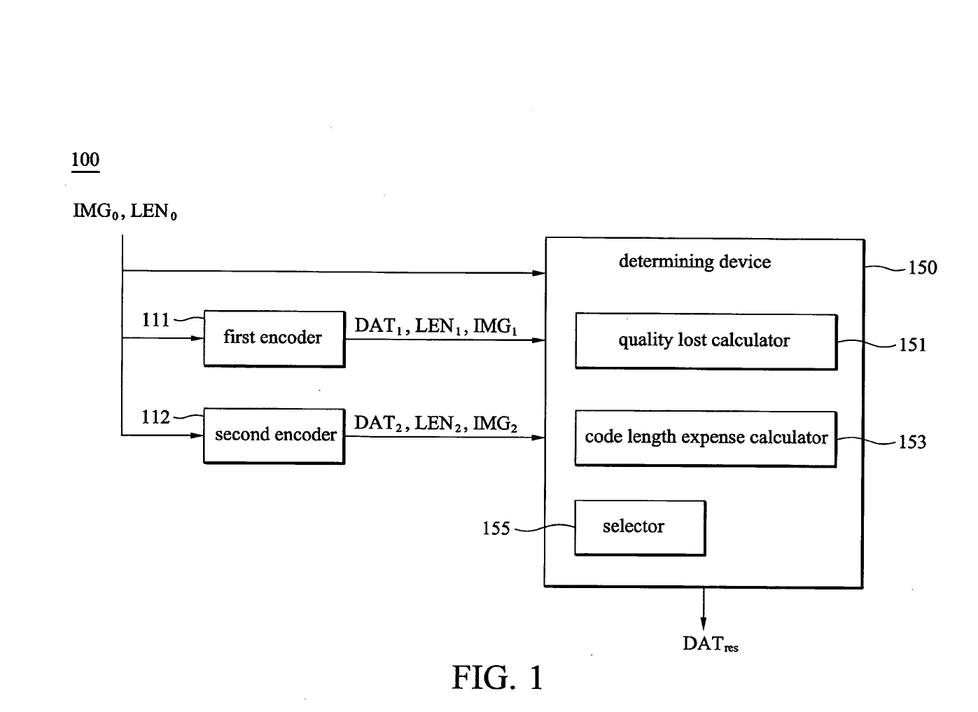

FIG. 1 is a diagram illustrating the system of image compression with quality control disclosed in the embodiment of the invention. The system 100 comprises a first encoder 111, a second encoder 112, and a determining device 150. Determining device 150 further comprises a quality lost calculator 151, a code length expense calculator 153 and a selector 155. System 100 receives an original image data IMG₀ of a plurality of pixels with an original length LEN₀, and outputs a result data DATᵣₑₛ as a coded data. The pixels comprised in IMG₀ may be a subset of pixels in a frame. In the beginning, the first encoder 111 encodes the original image data IMG₀ to be a first coded data DAT₁ with a first length LEN₁. Moreover, the first encoder 111 obtains a first image data IMG₁ of a plurality of pixels in which IMG₁ is the decoding image data of the first coded data DAT₁. At the same time, the second encoder 112 encodes the original image data IMG₀ to be a second coded data DAT₂ with a second length LEN₂, and obtains a second image data IMG₂ of a plurality of pixels in which IMG₂ is a decoding image data of the second coded data DAT₂. The first encoder 111 and the second encoder 112 encode IMG₀ according to different predetermined coding methods, such as DCT (Discrete Cosine Transform, DCT) and DWT (Discrete Wavelet Transform, DWT), respectively.

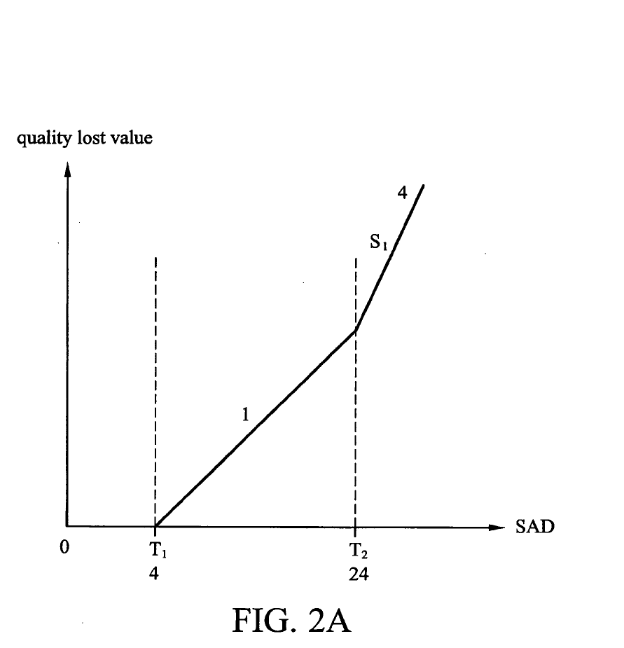

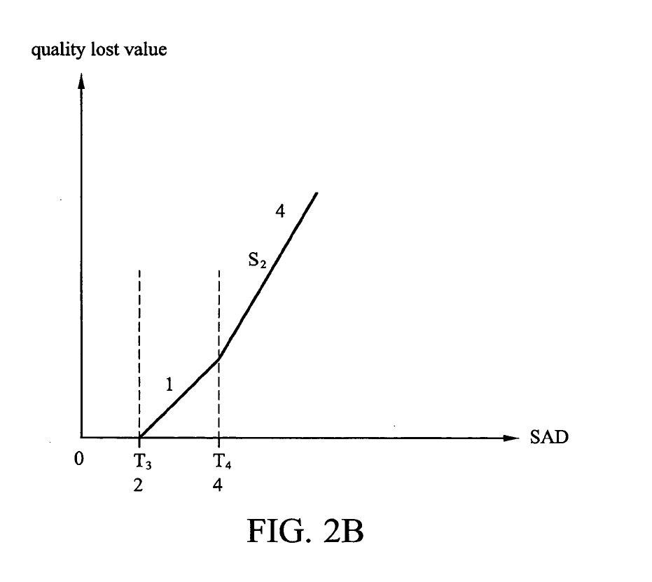

Further, determining device 150 receives the original image data IMG₀ with the original length LEN₀, the first coded data DAT₁ with LEN₁, the first image data IMG₁, the second coded data DAT₂ with LEN₂ and the second image data IMG₂, and selects the result data DATᵣₑₛ between DAT₁ and DAT₂ according to quality lost value and code length expense of DAT₁ and DAT₂. First, quality lost calculator 151 calculates the sum of absolute difference (SAD) between the pixels in IMG₀ and the one in IMG₁ as SAD₁, and calculates the sum of absolute difference (SAD) between the pixels in IMG₀ and the one in IMG₂ as SAD₂. Then, quality calculator 151 calculates a first quality lost value QLV₁ for DAT₁ and a second quality lost value QLV₂ for DAT₂ according to SAD₁ and SAD₂ based on a predetermined correlation between the SAD and the quality lost value, respectively. Referencing FIGS. 2A and 2B, FIG. 2A is a linear chart illustrating the predetermined correlation between SAD and the quality lost value while the original image data is in a high frequency region in the embodiment of the invention. FIG. 2B is a linear chart illustrating a predetermined correlation between the SAD and the quality lost value while the original image data is in a low frequency region in the embodiment of the invention. The correlations are not limited to the disclosed linear correlations in FIG. 2A and FIG. 2B. In FIGS. 2A and 2B, each x-axis represents the SAD and the y-axis represents the quality lost value. The slope between T₁ and T₂ and the slope between T₃ and T₄ are both 1 in the embodiment. The slopes are not limited to 1 and the correlations are not limited to linear correlations. The correlations may be nonlinear correlations, for example, the correlations may be curvilinear. According to the acceptability of human sight, the thresholds T₁, T₂, T₃ and T₄ and the slopes S₁ and S₂ in FIGS. 2A and 2B may be predetermined by users. In a preferred embodiment, T₁, T₂, T₃ and T₄ are respectively 4, 24, 2 and 4, and both of S₁ and S₂ are 4. After quality calculator 151 determines the original image data IMG₀ is in a high frequency region or in a low frequency region, QLV₁ and QLV₂ are determined according to SAD₁ and SAD₂ as shown in FIGS. 2A and 2B by quality calculator 151, respectively. In the embodiment, should IMG₀ be in the high frequency region, QLV₁ is 0 if SAD₁ is smaller than 4; QLV₂ is 0 if SAD₂ is smaller than 4; QLV₁ is equal to SAD₁ if SAD₁ is between 4 and 24; QLV₂ is equal to SAD₂ if SAD₂ is between 4 and 24; QLV₁ is equal to 4×SAD₁ if SAD₁ is larger than 24; QLV₂ is equal to 4×SAD₂ if SAD₂ is larger than 24. Alternatively, should IMG₀ be in the low frequency region, QLV₁ is 0 if SAD₁ is smaller than 2; QLV₂ is 0 if SAD₂ is smaller than 2; QLV₁ is equal to SAD₁ if SAD₁ is between 2 and 4; QLV₂ is equal to SAD₂ if SAD₂ is between 2 and 4; QLV₁ is equal to 4×SAD₁ if SAD₁ is larger than 4; QLV₂ is equal to 4×SAD₂ if SAD₂ is larger than 4.

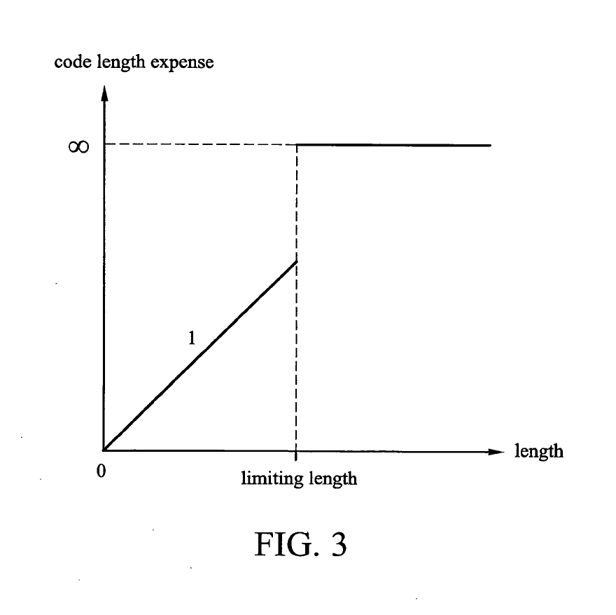

Further, code length expense calculator 153 calculates a first code length expense CLE₁ according to LEN₁ and a second code length expense CLE₂ according to LEN₂ based on a predetermined correlation between the length and the code length expense. FIG. 3 is a linear chart illustrating the predetermined correlation between the length and the code length expense. The x-axis represents the length and the y-axis represents the code length expense. The limiting length is predetermined which may be decided by users. The slope between 0 and the limiting length is 1. In the embodiment, CLE₁ is infinite when LEN₁ is larger than the predetermined limiting length and CLE₂ is infinite when LEN₂ is larger than the predetermined limiting length; otherwise, CLE₁ is the same as LEN₁ and CLE₂ is the same as LEN₂.

After QLV₁, QLV₂, CLE₁ and CLE₂ are obtained, selector 155 calculates a first total expense value TEV₁ for DAT₁ by TEV₁=α×QLV₁+β×CLE₁, and a second total expense value TEV₂ for DAT₂ by TEV₂=α×QLV₂+β×CLE₂. Where α and β are weights of the quality lost value and the code length expense, respectively, and may be predetermined by users. Finally, selector 155 selects the result data DATᵣₑₛ between DAT₁ and DAT₂ according to TEV₁ and TEV₂. For example, selector 155 selects DAT₁ to be the result data DATᵣₑₛ if TEV₁<TEV₂ which means the total expense value of DAT₁ is smaller than the one of DAT₂, and selects DAT₂ to be the result data DATᵣₑₛ if TEV₁>TEV₂.

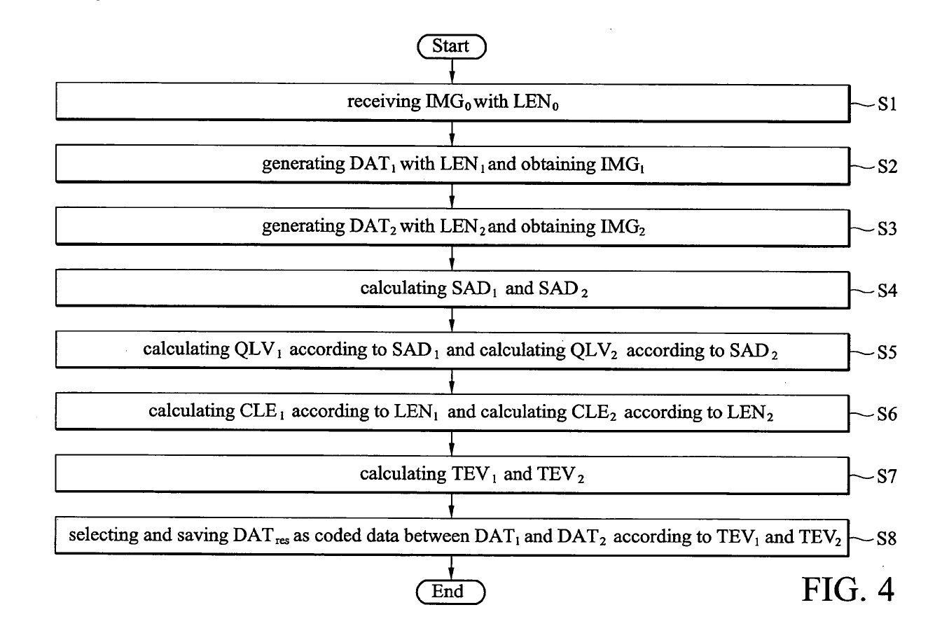

FIG. 4 is a flowchart of the method of image compression with quality control. First, an original image data IMG₀ with an original length LEN₀ is received by first encoder 111 and second encoder 112. (S1) A first coded data DAT₁ is generated with a first length LEN₁ by first encoder 111 encoding IMG₀ based on a first predetermined encoding method such as DCT, for example. A first image data IMG₁ which is the decoding image data of DAT₁ is obtained by first encoder 111. (S2) A second coded data DAT₂ is generated with a second length LEN₂ by second encoder 112 encoding IMG₀ based on a second predetermined encoding method such as DWT, for example. A second image data IMG₂ which is the decoding image data of DAT₂ is obtained by second encoder 112. (S3) Then determining device 150 receives IMG₀ with LEN₀, DAT₁ with LEN₁, DAT₂ with LEN₂, IMG₁ and IMG₂.

SAD₁, the sum of the absolute differences (SAD) between the pixels in the original image data IMG₀ and the pixels in the first image data IMG₁, is calculated and temporarily saved. Similarly, SAD₂, the SAD between the pixels in the original image data IMG₀ and the pixels in the second image data IMG₂, is calculated and temporarily saved. (S4) The first quality lost value QLV₁ and the second quality lost value QLV₂ are calculated and temporarily saved according to SAD₁ and SAD₂ based on the predetermined correlation between SAD and the quality lost value as shown in FIGS. 2A and 2B, respectively. (S5) The first code length expense CLE₁ and the second code length expense CLE₂ are calculated and temporarily saved according to LEN₁ and LEN₂ based on the predetermined correlation between the length and the code length expense as shown in FIG. 3, respectively. (S6) The first and second total expense values TEV₁ and TEV₂ are calculated by TEV₁=α×QLV₁+β×CLE₁ and TEV₂=α×QLV₂+β×CLE₂. (S7) Where α and β are weights of the quality lost value and the code length expense. Finally, a result data DATᵣₑₛ as coded data is selected between DAT₁ and DAT₂ according to TEV₁ and TEV₂ and saved in storage. (S8)

In (S5), whether the original image data IMG₀ is in a high frequency region or a low frequency region is determined first. If IMG₀ is in a high frequency region, QLV₁ and QLV₂ are calculated as shown in FIG. 2A. Otherwise, QLV₁ and QLV₂ are calculated as shown in FIG. 2B. After determining the frequency region, the corresponding quality lost value is obtained according to SAD₁ and SAD₂. Should IMG₀ be in a high frequency region, QLV₁ is 0 if SAD₁ is smaller than 4; QLV₂ is 0 if SAD₂ is smaller than 4; QLV₁ is 4×SAD₁ if SAD₁ is larger than 24; QLV₂ is 4×SAD₂ if SAD₂ is larger than 24; QLV₁ is SAD₁ if SAD₁ is between 4 and 24; QLV₂ is SAD₂ if SAD₂ is between 4 and 24. Alternatively, should IMG₀ be in a low frequency region, QLV₁ is 0 if SAD₁ is smaller than 2; QLV₂ is 0 if SAD₂ is smaller than 2; QLV₁ is 4×SAD₁ if SAD₁ is larger than 4; QLV₂ is 4×SAD₂ if SAD₂ is larger than 4; QLV₁ is SAD₁ if SAD₁ is between 2 and 4; QLV₂ is SAD₂ if SAD₂ is between 2 and 4.

In (S6), whether CLE₁ and/or CLE₂ are/is over the predetermined limiting length is determined. Then, the corresponding code length expense is obtained according to LEN₁ and LEN₂. In the embodiment, referencing FIG. 3, CLE₁ is infinite if LEN₁ is over the predetermined limiting length and CLE₂ is infinite if LEN₂ is over the predetermined limiting length; otherwise, CLE₁ is the same as LEN₁ and CLE₂ is the same as LEN₂.

In (S8), after obtaining TEV₁ and TEV₂ for DAT₁ and DAT₂, the result data DATᵣₑₛ is selected to be DAT₁ if TEV₁<TEV₂ which means the total expense value of DAT₁ is smaller than the one of DAT₂. If TEV₁<TEV₂, DATᵣₑₛ is selected to be DAT₂.

By the disclosed system and method, the encoding method with the best compression rate under a requested quality is selected to encode the original image data. Different parts in an image may be encoded by an adapted encoding method dynamically in the disclosed system and method to achieve the best compression rate under acceptable quality.

Systems and methods, or certain aspects or portions thereof, may take the form of a program code (i.e., instructions) embodied in a tangible media, such as floppy diskettes, CD-ROMS, hard drives, or any other machine-readable storage medium, wherein, when the program code is loaded into and executed by a machine, such as a computer system and the like, the machine becomes an apparatus for practicing the invention. The disclosed methods and apparatuses may also be embodied in the form of a program code transmitted over some transmission medium, such as electrical wiring or cabling, through fiber optics, or via any other form of transmission, wherein, when the program code is received and loaded into and executed by a machine, such as a computer or an optical storage device, the machine becomes an apparatus for practicing the invention. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system of image compression, comprising:
a first encoder configured to generate a first coded data;
a second encoder configured to generate a second coded data; and
a determining device configured to receive the first coded data and the second coded data, comprising:
a quality lost calculator configured to calculate a first quality lost value of the first coded data and a second quality lost value of the second coded data;
a code length expense calculator configured to calculate a first code length expense of the first coded data and a second code length expense of the second coded data; and
a selector configured to calculate a first total expense value according to the first quality lost value and the first code length expense, calculate a second total expense value according to the second quality lost value and the second code length expense, and to selectively output one of the first coded data and the second coded data according to the first total expense value and the second total expense value.

2. The system as claimed in claim 1, wherein the first quality lost value is calculated according to a first image data and an original image, and the second quality lost value is calculated according to a second image data and the original image data.

3. The system as claimed in claim 2, wherein the first image data is decoded from the first coded data and the second image data is decoded from the second coded data.

4. The system as claimed in claim 2, wherein the first quality lost value is calculated according to a first sum of absolute differences (SAD) between pixels in the original image data and pixels in the first image data, and the second quality lost value is calculated according to a second sum of absolute differences (SAD) between the pixels in the original image data and pixels in the second image data.

5. The system as claimed in claim 1, wherein the quality lost calculator further determines whether the original image data is in a high frequency region or not.

6. The system as claimed in claim 1, wherein the first code length expense of the first coded data is calculated according to a first length of the first coded data, and the second code length expense of the second coded data is calculated according to a second length of the second coded data.

7. The system as claimed in claim 6, wherein the first code length expense is determined as infinite when the first length is over a predetermined limiting length, the first code length expense is determined as the first length when the first length is under the predetermined limiting length, the second code length expense is determined as infinite when the second length is over the predetermined limiting length, and the second code length expense is determined as the second length when the second length is under the predetermined limiting length.

8. The system as claimed in claim 1, wherein the first coded data is generated by encoding an original image data according to a first data compression method and the second coded data is generated by encoding the original image data according to a second data compression method.

9. A method of image compression comprising the steps of:
generating a first coded data;
generating a second coded data;
calculating a first quality lost value of the first coded data, a second quality lost value of the second coded data;
calculating a first code length expense of the first coded data, a second code length expense of the second coded data;
calculating a first total expense value according to the first quality lost value and the first code length expense;
calculating a second total expense value according to the second quality lost value and the second code length expense; and
selectively outputting one of the first coded data and the second coded data according to the first total expense value and the second total expense value.

10. The method as claimed in claim 9, wherein the first quality lost value is calculated according to a first image data and an original image and the second quality lost value is calculated according to a second image data and the original image data.

11. The method as claimed in claim 10, wherein the first image data is decoded from the first coded data and the second image data is decoded from the second coded data.

12. The method as claimed in claim 10, further comprising the steps of:
calculating a first sum of absolute differences (SAD) between the pixels in the original image data and the pixels in the first image data; and
calculating a second sum of absolute differences (SAD) between the pixels in the original image data and the pixels in the second image data.

13. The method as claimed in claim 12, further comprising the steps of:
determining the first quality lost value as 0 when the first SAD is smaller than a first predetermined value while the original image data is in a high frequency region; and
determining the second quality lost value as 0 when the second SAD is smaller than a third predetermined value while the original image data is not in a high frequency region.

14. The method as claimed in claim 12, further comprising the steps of:
determining the first quality lost value as a multiple of the first SAD when the first SAD is larger than a second predetermined value while the original image data is in a high frequency region; and
determining the second quality lost value as a multiple of the second SAD when the second SAD is larger than a forth predetermined value while the original image data is not in a high frequency region.

15. The method as claimed in claim 12, further comprising the steps of:
determining the first quality lost value as the first SAD when the first SAD is between the first and the second predetermined value while the original image data is in a high frequency region; and
determining the second quality lost value as the second SAD when the second SAD is between the third and the forth predetermined value while the original image data is not in a high frequency region.

16. The method as claimed in claim 9, further comprising the step of determining whether the original image data is in a high frequency region or not.

17. The method as claimed in claim 9, wherein the first code length expense of the first coded data is calculated according to a first length of the first coded data, and the second code length expense of the second coded data is calculated according to a second length of the second coded data.

18. The method as claimed in claim 9, further comprising the steps of:
determining the first code length expense as infinite when the first length is over a predetermined limiting length;
determining the second code length expense as infinite when the second length is over the predetermined limiting length;
determining the first code length expense as the first length when the first length is under the predetermined limiting length; and
determining the second code length expense as the second length when the second length is under the predetermined limiting length.

19. The method as claimed in claim 9, further comprising the steps of:
calculating the first total expense by summing up a product of a first weight and the first quality lost value and a product of a second weight and the first code length expense; and
calculating the second total expense by summing up a product of the first weight and the second quality lost value and a product of the second weight and the second code length expense.

20. The method as claimed in claim 9, wherein the first coded data is generated by encoding an original image data according to a first data compression method and the second coded data is generated by encoding the original image data according to a second data compression method.
